(19) United States
(12) Patent Application Publication
(10) Pub. No.: US 2007/0204099 A1
(43) Pub. Date: Aug. 30, 2007

(54) Methods for programming NAND flash memory and memory system

(76) Inventors: Seon-Taek Kim, Suwon-si (KR); Chan-Ik Park, Seoul (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/585,242

(22) Filed: Oct. 24, 2006

(30) Foreign Application Priority Data
Feb. 28, 2006 (KR) 2006-19482

(51) Int. Cl. G06F 12/00

(52) U.S. Cl. 711/103; 711/202

(57) ABSTRACT

A method of programming a memory system including a flash memory comprising; in response to a conventional data input command, sequentially executing an address mapping operation, an address input operation, a load data operation, and a program execution operation, or in response to a new data input command, sequentially executing a load data operation, an address input operation, and a program execution operation, and further executing an address mapping operation in parallel with the load data operation.

### BACKGROUND OF THE INVENTION

1. Field of the Invention

Embodiments of the invention relate generally to a memory systems and memory systems including flash memory devices. More particularly, embodiments of the invention relate to a method of programming memory cells in a memory system including flash memory devices.

This patent application claims priority under 35 U.S.C § 119 to Korean Patent Application 2006-19482 filed on Feb. 28, 2006, the subject matter of which is hereby incorporated by reference.

2. Discussion of Related Art

Many different types of consumer electronics use semiconductor memory devices to store data. Semiconductor memory devices may be roughly divided into Random Access Memories (RAM) and Read Only Memories (ROM). RAM is typically formed using volatile memory devices that lose stored data when the power is turned off. In contrast, ROM is typically formed using non-volatile memory devices that retain stored data even in the absence of applied power. RAM include dynamic random access memories (DRAM), static random access memories (SRAM), etc. ROM includes programmable ROMs, erasable PROMs, electrically ERPOMs, flash memories, etc. Common flash memories types include NAND flash memories and NOR flash memories.

In general, a NAND flash memory includes a memory cell array, divided into a plurality of memory blocks. Each memory block is further divided into a plurality of pages. Erase operations are conventionally performed in NAND flash memory devices on a block unit basis. Whereas, programming and read operations are performed on a page unit basis. Thus, in conventional NAND flash memory devices, the programming and read operations differ in their unit size application from the erase operation. Thus, it is necessary to independently manage the execution of programming/read operations from erase operations in a memory system including NAND flash memory. This is particularly the case where NAND flash memory is intended to replace the conventional use of a hard disk in a host device. In order to control the independent execution of these three (3) basic operations, a specialized system software has been developed which is commonly referred to as “flash translation layer” or “FTL”.

The FTL converts logical addresses into physical addresses, manages so-called “bad blocks”, manages data security functions, such as those related to an unexpected loss of power, manages wear and tear on the physical storage media, etc. Hereafter, the multiplicity of different techniques used to convert logical addresses to physical addresses will be collectively and individually referred to as “address mapping operation”.

Memory systems including conventional NAND flash memory are configured to sequentially perform an address mapping operation controlled by the FTL, as well as an actual data programming operation of the NAND flash memory. Logical addresses are converted into physical addresses through the address mapping operation in order to accomplish programming on a page unit basis within the NAND flash memory. Then, the converted physical addresses are provided to the NAND flash memory, and page data is loaded into a page buffer within the NAND flash memory. Data loaded into the page buffer is then programmed to a selected page of the memory cell array.

Thus, in a conventional memory system including NAND flash memory, an address mapping operation is performed before a programming operation is performed. In such cases wherein page data is programmed in the NAND flash memory, the address mapping operation requires between about 20 to 30 percent of the total time required to execute the programming operation. This additional delay tends to decrease overall programming efficiency within a memory system including NAND flash memory.

### SUMMARY OF THE INVENTION

Embodiments of the invention are directed to a method of programming a non-volatile flash memory which comprises loading data to a page buffer, receiving the address of the designated page, and programming the loaded data from the page buffer.

In one embodiment, the invention provides a method of programming a memory system including a flash memory comprising; in response to a conventional data input command, sequentially executing an address mapping operation, an address input operation, a load data operation, and a program execution operation, or in response to a new data input command, sequentially executing a load data operation, an address input operation, and a program execution operation, and further executing an address mapping operation in parallel with the load data operation.

In another embodiment, the invention provides a method of programming a memory system, the memory system comprising; a NAND flash memory, comprising a memory cell array and a page buffer, a flash controller adapted to control a programming operation for the NAND flash memory, a buffer memory adapted to store data to be programmed to the NAND flash memory, and a work memory adapted to perform an address mapping operation under the control of a central processing unit, The method of programming comprises; providing a data input command from the flash controller to the NAND flash memory and determining whether the received data input command is a conventional data input command or a new data input command, and differently determining the execution order of a data load operation and an address input operation responsive to mapping address information stored in the work memory in response to the determination of whether the received data input command is a conventional data input command or a new data input command.

### BRIEF DESCRIPTION OF THE DRAWINGS

Figure (FIG.) 1 is a block diagram showing a memory system according to one embodiment of the invention.

FIG. 2 is a flowchart showing a programming method adapted for use with the memory system illustrated in FIG. 1.

FIG. 3 is a timing diagram related to an exemplary programming operation for a NAND flash memory.

FIG. 4 is a timing diagram related to an exemplary programming operation for a NAND flash memory.

FIG. 5 is a timing diagram relating subroutines in an exemplary programming operation as compared to a conventional programming operation.

### DESCRIPTION OF EMBODIMENTS

The present invention will now be described in some additional detail with reference to several embodiments illustrated in the accompanying drawings. However, the invention may be variously embodied and should not be construed as being limited to only the embodiments set forth herein. Rather, the embodiments are presented as teaching examples. In the drawings, like numbers refer to like or similar elements.

FIG. 1 is a block diagram of a memory system according to one embodiment of the invention. Referring to FIG. 1, a memory system 200 is connected to a host 100 and includes an interface device 300 and a NAND flash memory 400. Memory system 200 is configured to control NAND flash memory 400 when access to NAND flash memory 400 is requested by host 100. For example, memory system 200 is configured to control read, programming and erase operations associated with NAND flash memory 400.

Interface device 300 includes a host interface 310, a central processing unit 320, a work memory 340, and a flash controller 350. Host interface 310 interfaces with host 100 and central processing unit 320 controls the overall operation of memory system 200.

Work memory 330 is used to store software implementing, among other functions, the FTL and is controlled by central processing unit 320. Work memory 330 may be further utilized to store address mapping information for NAND flash memory 400. Address mapping information may be is stored in any region (e.g., a meta region) of NAND flash memory 400 and may be automatically loaded to work memory 330 upon power-up of memory system 200.

Work memory 330 receives a logical address from host 100 and converts the logical address to a physical address using the address mapping information. The physical address is sometimes referred to as a “mapping address.” The physical address or mapping address is provided to NAND flash memory 400.

The software implementing the FTL may also be stored in any region (e.g., a boot code region) of NAND flash memory 400 and automatically loaded to work memory 330 upon power-up of memory system 200.

Buffer memory 340 is used to temporally store data to be programmed into NAND flash memory 400 or data being read from NAND flash memory 400. During a programming operation, buffer memory 340 may be configured to provide data to a page buffer 420 within NAND flash memory 400 and simultaneously receive data from host 100.

Each of work memory 320 and buffer memory 330 may be implemented by one or more volatile memory devices, such as SRAM or DRAM. In FIG. 1, work memory 330 and buffer memory 340 separately embodied in different memory devices, but could very readily be implemented in a single memory device.

Flash controller 350 is configured to control an access operation (e.g., a read, programming or erase operation) to NAND flash memory 400 under the control of central processing unit 320. In case of a programming operation, flash controller 350 provides a data input command, a program command, an address, and program data to NAND flash memory 400. In the illustrated example “program data” is assumed to be data stored in buffer memory 340.

NAND flash memory 400 includes a memory cell array 410 and a page buffer 420. Memory cell array 410 is divided into a plurality of memory blocks (not shown). Each memory block is further divided into a plurality of pages. In the illustrated example and consistent with conventional practice, NAND flash memory 400 is assumed to perform erase operations in on a block unit basis and programming or read operations on a page unit basis. Each memory block in memory cell array 410 may be allocated for use as a data region, a log region, and a meta region. Further, one or more memory blocks in memory cell array 410 may be used to store boot code and/or software implementing a FTL. Page buffer 420 is adapted to store data to be programmed to memory cell array 410 during a programming operation and data being read from memory cell array 410 during a read operation.

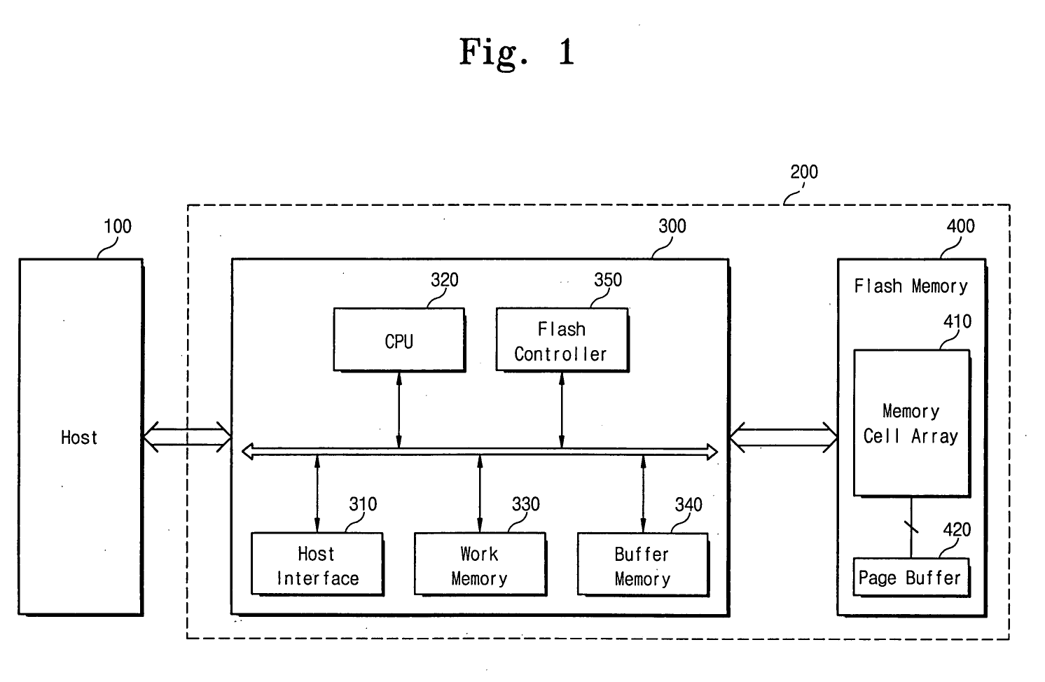

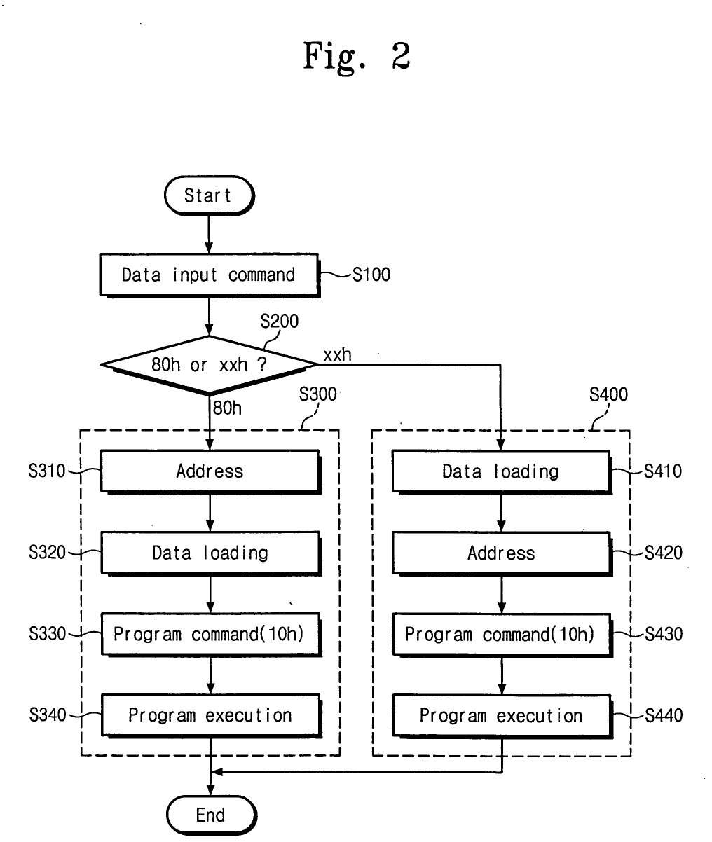

FIG. 2 is a flowchart showing an exemplary programming method for a memory system such as the one illustrated in FIG. 1. This programming method will be described with reference to FIGS. 1 and 2.

In step S100, a data input command is provided to NAND flash memory 400. Flash controller 350 issues the data input command to NAND flash memory 400 at the onset of the programming operation. NAND flash memory 400 receives the data input command via input/output terminals and discriminates the data input command based on a combination of conventionally understood control signals such as nCE, CLE, ALE, nWE, and so on.

In step S200, a determination is made as to whether the data input command is a conventional input command OLD_CMD (e.g., 80h) or a new command NEW_CMD (e.g., xxh) (wherein, “x” is a hexadecimal numbers). If the data input command is a conventional command, the method branches to step S300. If, however, the data input command is a new command, the method branches to step S400. The conventional data input command 80h may be consistent with the commands documented in the data book entitled “NAND FLASH MEMORY” conventionally available from Samsung Electronics Co., Ltd. However, such conventional data input commands are not limited to only those set forth in this data book and may be variously configured (e.g., a 10h program command).

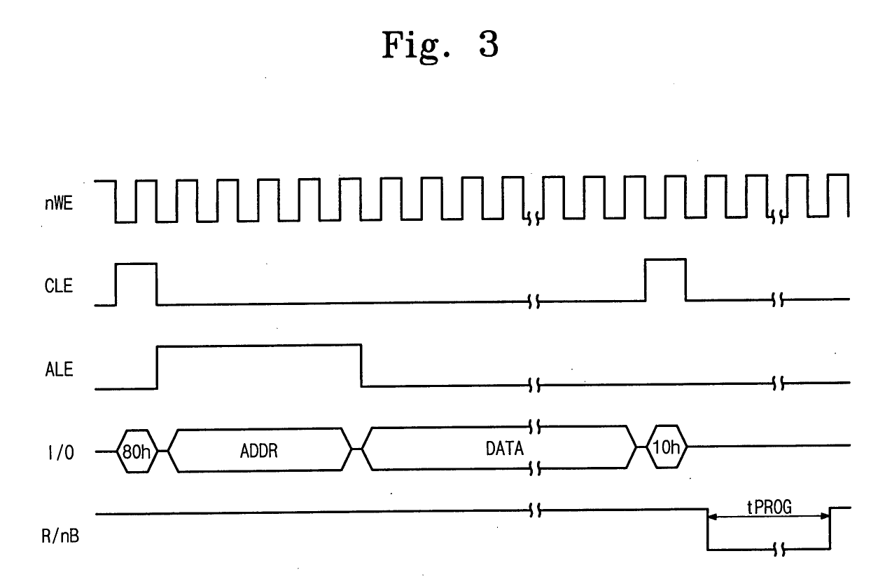

In step S300, an address input operation S310, a data load operation S320, a program command execution operation S330, and a program execution operation S340 are sequentially carried out. During the address input operation, a physical address is sent to NAND flash memory 400 from work memory 330. During the data load operation S320, data is loaded to page buffer 430 of NAND flash memory 400 from buffer memory 340. In step S300, after the address input operation is carried out, the data load operation is performed. One more detailed version of step S300 will be described with reference to FIG. 3.

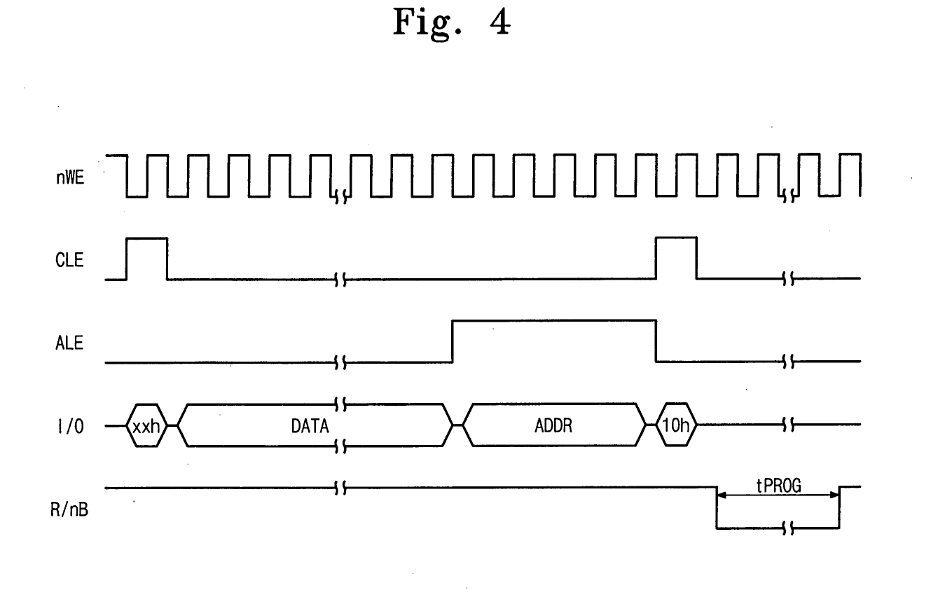

In step S400, a data load operation S410, an address input operation S420, a program command input operation S430, and a program execution operation S440 are sequentially carried out. In step S400, the address input operation is made after the data load operation S410 is performed. One more detailed version of step S400 will be described with reference to FIG. 4.

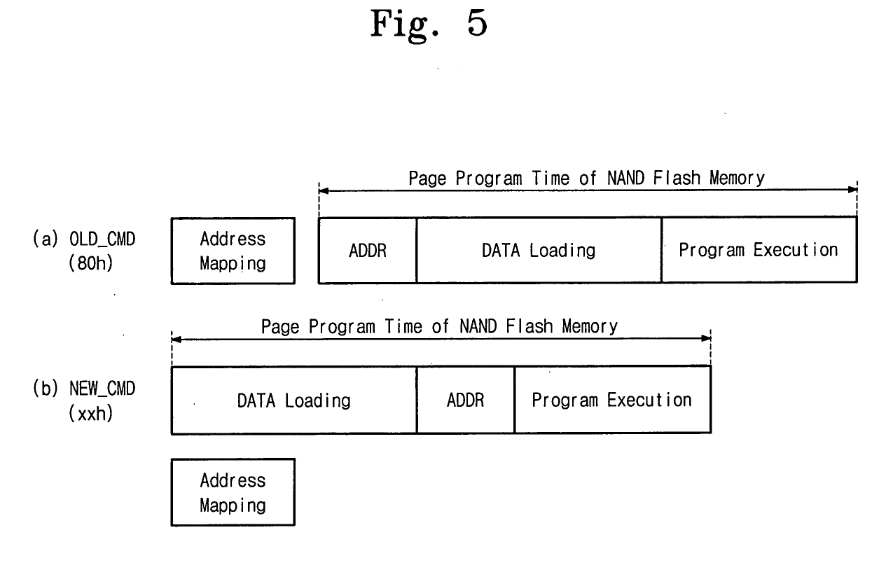

According to a program method adapted for use with memory system 200, after a data input command is transferred to NAND flash memory 400 from flash controller 340, the order in which the data load operation and the address input operation are differently determined on the basis of the data input command type. For example, in a case where the data input command is a conventional command 80h, the data load operation (S320) is performed after execution of the address input operation S310. On the other hand, in a case where the data input command is a new command xxh, the address input operation (S420) is performed after execution of the data load operation (S410). Upon input of the new command xxh, while the data load operation (S410) is being carried out, an address mapping operation may be simultaneously performed. Accordingly, it is possible to reduce the total programming time, as will be further illustrated with reference to FIG. 5.

FIG. 3 is a timing diagram showing a programming operation for NAND flash memory 400 within the exemplary context of step S300 in the flowchart of FIG. 2. FIG. 4 is a timing diagram showing a programming operation for NAND flash memory 400 within the exemplary context of step S400 in the flowchart of FIG. 2.

Referring to FIGS. 3 and 4, NAND flash memory 400 receives a command, an address, and data via input/output terminals in accordance with a combination of conventionally understood control signals, such as nWE, CLE, ALE, and so on. As an example, the control signal nWE is a write enable signal, the control signal CLE is a command latch enable signal, and the control signal ALE is an address latch enable signal. Within NAND flash memory 400, the data loaded into page buffer 420 is then programmed to a selected page of memory cell array 410 during a low-level period of an R/nB signal.

Referring to FIG. 3, NAND flash memory 400 receives a data input command 80h in response to the command latch enable signal CLE and an address in response to the address latch enable signal ALE. NAND flash memory 400 receives data stored in buffer memory 340 in synchronization with transitions of the write enable signal nWE. The received data is stored in page buffer 420. NAND flash memory 400 receives a program command 10h in response to the command latch enable signal CLE. The program command 10h is also called a “confirm command”. Afterwards, during a programming execution period tPGM, the loaded data in page buffer 420 may be programmed to a selected page of memory cell array 410.

FIG. 5 is a timing diagram showing a program time of a memory system illustrated in FIG. 1. FIG. 5a shows the case that a conventional command 80h is received at a program operation and FIG. 5b shows the case that a new command xxh is received at the program operation a memory system 200 performs an address mapping operation and then sends a mapping address to the NAND flash memory 400.

Referring to FIG. 5a, an address is provided to NAND flash memory 400, and then data is loaded. After the address mapping operation is completed, NAND flash memory 400 performs a programming operation. On the other hand, as illustrated in FIG. 5b, since an address is received after loading of data to NAND flash memory 400, the address mapping operation may be performed during the data load operation.

Thus, in accordance with a programming method adapted for use with a memory system consistent with an embodiment of the present invention, it is possible to reduce the total programming time through simultaneous execution of a programming operation and an address mapping operation.

Furthermore, since a new command is added while a conventional command scheme is also enabled, the programming method of the present invention may be applied to a system already configured for use with a conventional NAND flash memory. In accordance with an embodiment of the present invention, the programming method for NAND flash memory and/or the programming method for a memory system including a NAND flash memory may also be applied to a memory card, such as Multi-Media Card (MMC).

Although the present invention has been described in connection with illustrated embodiments, it is not limited thereto. It will be apparent to those skilled in the art that various substitution, modifications and changes may be thereto without departing from the scope of the invention as defined by the following claims.

What is claimed is:

1. A method of programming a memory system including a flash memory comprising:
in response to a conventional data input command, sequentially executing an address mapping operation, an address input operation, a load data operation, and a program execution operation; or
in response to a new data input command, sequentially executing a load data operation, an address input operation, and a program execution operation, and further executing an address mapping operation in parallel with the load data operation.

2. The method of claim 1 further comprising:
receiving a data input command and determining whether the received data input command is a conventional data input command or a new data input command.

3. The method of claim 2, wherein the program execution operation comprises executing either the conventional data input command or the new data input command.

4. The method of claim 3, wherein the address mapping operation converts a logical address into a physical address.

5. The method of claim 4, wherein the address mapping operation is executed under the control of a flash translation layer (FTL) program.

6. The method of claim 2, wherein the load data operation comprises loading data to a page buffer associated with the flash memory, and following execution of the load data operation, data loaded into the page buffer is programmed to a designated memory page.

7. A method of programming a memory system, the memory system comprising:
a NAND flash memory, comprising a memory cell array and a page buffer,
a flash controller adapted to control a programming operation for the NAND flash memory,
a buffer memory adapted to store data to be programmed to the NAND flash memory, and
a work memory adapted to perform an address mapping operation under the control of a central processing unit,
the method comprising:
providing a data input command from the flash controller to the NAND flash memory and determining whether the received data input command is a conventional data input command or a new data input command; and,
differently determining the execution order of a data load operation and an address input operation responsive to mapping address information stored in the work memory in response to the determination of whether the received data input command is a conventional data input command or a new data input command.

8. The method of claim 7, wherein in response to a conventional data input command, sequentially executing an address mapping operation, an address input operation, a load data operation, and a program execution operation.

9. The method of claim 7, wherein in response to a new data input command, sequentially executing a load data operation, an address input operation, and a program execution operation, and further executing an address mapping operation in parallel with the load data operation.

10. The method of claim 7, wherein data stored in the buffer memory is loaded to the page buffer during the data load operation.

11. The method of claim 8, wherein following execution of the address input operation,
a program command is provided from the flash controller to the NAND flash memory, and
the data loaded into the page buffer is programmed to the memory cell array in response to the program command.

12. The method of claim 9, wherein following execution of the address input operation,
a program command is provided from the flash controller to the NAND flash memory, and
the data loaded into the page buffer is programmed to the memory cell array in response to the program command.
